(19) United States
(12) Patent Application Publication
(10) Pub. No.: US 2015/0018153 A1
(43) Pub. Date: Jan. 15, 2015

(54) METHOD FOR CONTROLLING A POWER SPLIT CONTINUOUSLY VARIABLE TRANSMISSION AND A POWER SPLIT CONTINUOUSLY VARIABLE TRANSMISSION

(71) Applicants: Daniel Stålberg, Eskilstuna (SE); Per Mattsson, Hindas (SE); Andreas Nordstrand, Eskilstuna (SE)

(72) Inventors: Daniel Stålberg, Eskilstuna (SE); Per Mattsson, Hindas (SE); Andreas Nordstrand, Eskilstuna (SE)

(73) Assignee: VOLVO CONSTRUCTION EQUIPMENT AB, Eskilsturna (SE)

(21) Appl. No.: 14/127,790

(22) PCT Filed: Jun. 21, 2011
(86) PCT No.: PCT/SE2011/000120

§ 371 Date: Feb. 3, 2014

(51) Int. Cl. F16H 47/10; F16H 61/66; F16H 61/02

(52) U.S. Cl. CPC F16H 47/10; F16H 61/0262; F16H 61/66
USPC 475/33

(57) ABSTRACT

A power split continuously variable transmission is provided including a variator unit having a first and a second variable displacement hydrostatic machine and a planetary gear unit. The power split continuously variable transmission is arranged to be controlled to perform a simultaneous reduction of displacements of the first and second variable displacement hydrostatic machines during at least a part of a lock up state of the power split continuously variable transmission. A method of operating such a transmission is also provided.

### BACKGROUND AND SUMMARY

The invention relates, according to an aspect thereof to a method for controlling a power split continuously variable transmission and a power split continuously variable transmission.

Power split continuously variable transmissions include a mechanical transmission and a variator unit. The mechanical transmission includes a planetary gear unit consisting of one or more planetary gear trains and may also include one or more conventional gear stages. In the mechanical transmission power is transmitted over meshing gear wheels allowing high transmission efficiency at fixed gear ratios. The variator unit has a continuously variable speed ratio. In a power split continuously variable transmission an input power may be split to be distributed over the mechanical transmission and the variator unit to provide a variable overall speed ratio over the continuously variable transmission. The overall speed ratio over the continuously variable transmission is the speed ratio of an outgoing shaft to an incoming shaft. The same applies for the speed ratio of the variator unit. The continuously variable transmission may be operable in a plurality of modes. Each mode is then associated with an overall speed ratio range. The modes are selected by engagement and disengagement of a set of clutches, which by engagement and disengagement define different transmission paths over the continuously variable transmission. In each mode the overall speed ratio is changed by changing the speed ratio over the variator unit. The power split continuously variable transmissions provide for variable overall speed ratios over a relatively broad range by shifting modes and changing the speed ratio over the variator. A mode change of the mechanical transmission may take place when synchronism is present over one or more clutches to be engaged for providing operation in an upcoming mode, where the upcoming mode has an overall speed ratio range different than the overall speed ratio range of a current mode. The synchronism will be present at a specific speed ratio over the variator unit. At this speed ratio a mode change may take place h engagement of the one or more clutches providing the transmission paths of and defining the upcoming mode, and disengagement of one or more clutches providing the transmission paths of and defining a current mode. In order to allow for a high efficiency of the transmission the amount of power transmitted through the variator unit should be limited. Improved efficiency may be obtained by engaging the clutches so as to provide a fixed gear ratio over the continuously variable transmission at a specific working point of the transmission. The fixed gear ratio over the continuously variable transmission is provided by simultaneous engagement of clutches defining two separate modes. This state is referred to as a lock up state at which power is transmitted via meshed engagement over the mechanical transmission and essentially no power is transmitted over the variator unit.

Even if the possibility of providing a lock up state has improved, the efficiency of power split continuously variable transmissions, it is desirable to increase the efficiency further.

It is desirable to further increase the efficiency of a power split continuously variable transmission. A method according to an aspect of the invention relates to control of a transmission including a variator unit having a first and a second variable displacement hydrostatic machine and a planetary gear unit. The displacements of the first and second variable displacement hydrostatic machines are simultaneously reduced during at least a part of a lock up state of the power split continuously variable transmission.

During the lock up state the continuously variable transmission has a fixed gear ratio. All power is thus transmitted via the mechanical transmission. Hence, no torque needs to be transmitted over the variator unit. However, a flow between the first and second variable displacement hydrostatic machines may be present at the lock up state. This is the case when working areas with high variator power can be identified near points of mode changes where lock up takes place. The flow between the first and second variable displacement hydrostatic machines results in a loss of power, due to fluid flow losses. An aspect of invention contemplates reducing such losses by simultaneously reducing the displacement of the first and second variable displacement hydrostatic machines during at least a part of the lock up state. The actual flow and associated flow losses appearing in the power split continuously variable transmission will be reduced accordingly.

Preferably the reduction of displacement may be started as soon as the lock up state is initiated at synchronism over a clutch to be engaged to provide a fixed gear ratio over the continuously variable transmission. The lock up state is normally initiated by engagement of the clutch. The displacements of the first and second variable displacement hydrostatic machines have a value V1 and V2 before lock up takes place. These values are set to provide a desired speed ratio over the variator unit and to provide a desired torque transmitted over the variator unit. Once the lock up state is present, the displacements of the first and second variable displacement hydrostatic machines are reduced to finally assume reduced values v1 and v2 of the displacements. The displacements of the first and second variable displacement hydrostatic machines are set by separate actuators requiring a finite time for setting of the displacement. The quantity of reduction of the displacement may be adapted such that the displacements of the first and second variable displacement hydrostatic machines can reassume their initial values prior to termination of the lock up state. For this reason, the reduction of the displacements can be limited. A minimum value of the reduced values v1 and v2 may be decided based on accelerator pedal position, accelerator pedal position derivative, velocity data and acceleration data relating to the input shaft of the continuously variable transmission. In the event the degree of dynamics over the continuously variable transmission is low, that is, it is assumed that the rotational speed at the input shaft of the continuously variable transmission will be kept relatively constant for an extended period of time, the reduced values v1 and v2 may approach zero displacement.

Preferably the simultaneous reduction of the displacements is performed such that the ratio of the displacement of the first hydrostatic machine to the displacement of the second hydrostatic machine is kept essentially constant during the simultaneous reduction. By keeping the ratio of the displacements constant, it is ensured that a selected speed ratio over the variator unit, determined by the speed ratio of the lock up state, is maintained.

Preferably the mechanical transmission is operable in a first operating mode with a first speed ratio range by a selectively engagable first clutch, and in a second operating mode with a second speed ratio range by a selectively engagable second clutch. The lock up state may then be provided by engagement of both the first and second clutches to provide a fixed gear ratio over the power split continuously variable transmission.

The method according to an aspect of the invention is particularly suitable when changing between a first and second operating mode takes place at or nearby a maxima for a flow between the first and second hydrostatic machines in the variator unit. In for instance embodiments of power split continuously variable transmissions with a variator unit having a first and a second variable displacement hydrostatic machine and a planetary gear unit as shown in FIGS. 2a-2c, the mode change will take place at or nearby a maxima for the flow between the first and second hydrostatic machines in the variator unit. Reduction of the displacements of the first and second variable displacement hydrostatic machines is particularly beneficial for these embodiments, since a large flow is present at lock up state unless the reduction of displacements is made.

The method may be operated at a continuously variable transmission having one of a first and second operating modes with an increasing overall speed ratio over the power split continuously variable transmission at increasing variator speed ratio, and the other of the first and second operating modes with a decreasing overall speed ratio over the power split continuously variable transmission at increasing variator speed ratio. For such continuously variable transmission, speed ratio ranges intersect at a point with a common overall speed ratio over the power split continuously variable transmission. The first and second clutches may be controlled to be engaged at or nearby the point with a common overall speed ratio to provide the lock up state.

The invention also relates, according to an aspect thereof, to a power split continuously variable transmission including a variator unit having a first and a second variable displacement hydrostatic machine and a planetary gear unit. The power split continuously variable transmission is arranged to be controlled to perform a simultaneous reduction of displacements of the first and second variable displacement hydrostatic machines during at least a part of a lock up state of the power split continuously variable transmission. The reduction of the displacements is made by separate actuators for setting the displacement of respective first and second variable displacement hydrostatic machines.

In one embodiment the transmission is operable in a first operating mode with a first speed ratio range by a selectively engagable first clutch, and in a second operating mode with a second speed ratio range by a selectively engagable second clutch. The lock up state is provided by engagement of both the first and second clutches to provide a fixed gear ratio over the power split continuously variable transmission.

Optionally, the planetary gear unit includes a first, second and third shaft, the first shaft being connected to the first hydrostatic machine and being connectable to a prime mover, the second shaft being connected to the second hydrostatic machine and being selectively connectable to an output shaft by a first clutch, and the third shaft being selectively connectable to the output shaft via a second clutch. Such a power split continuously variable transmission may be operable in a hydrostatic mode by engagement of the first clutch and disengagement of the second clutch, the power split continuously variable transmission may further be operable in an input coupled shunt mode by engagement of the second clutch and disengagement of the first clutch, and the power split continuously variable transmission may also be operable in a lock up state by engagement of both the first and second clutches.

Optionally, the planetary gear unit includes a first, second, third and fourth shaft, the first shaft being connected to the first hydrostatic machine and being connectable to a prime mover, the second shaft being connected to the second hydrostatic machine, the third shaft being selectively connectable to an output shaft by a first clutch, and the fourth shaft being selectively connectable to the output shaft via a second clutch. Such a power split continuously variable transmission may be operable in a first input coupled shunt mode by engagement of the first clutch and disengagement of the second clutch, the power split continuously variable transmission may further be operable in a second input coupled shunt mode by engagement of the second clutch and disengagement of the first clutch, and the power split continuously variable transmission may also be operable in a lock up state by engagement of both the first and second clutches.

Optionally, the planetary gear unit includes a first, second, third and fourth shaft, the first shaft being connectable to a prime mover, the second shaft being connected to the in hydrostatic machine, the third shaft being selectively connectable to an output shaft by a first clutch, and the fourth shaft being connected to the second hydrostatic machine and being selectively connectable to the output shaft via a second clutch. Such a power split continuously variable transmission may be operable in a bridge mode by engagement of the first clutch and disengagement of the second clutch, the power split continuously variable transmission may farther be operable in an output coupled shunt mode by engagement of the second clutch and disengagement of the first clutch, and the power split continuously variable transmission may also be operable in a lock up state by engagement of both the first and second clutches.

### BRIEF DESCRIPTION OF DRAWINGS

The invention will be described in more detail below, with reference to appended drawings where,

FIG. 1 shows a schematic flow chart of a method according to the invention,

FIG. 2a shows a schematic drawing of a first embodiment of the invention,

FIG. 2b shows a schematic drawing of a second embodiment of the invention,

FIG. 2c shows a schematic drawing of a third embodiment of the invention,

FIG. 3 shows a fourth embodiment of the invention described in closer detail,

FIG. 4 shows a diagram with the overall speed ratio as a function of the variator speed ratio for the fourth embodiment of the invention,

FIG. 5 shows the variator power ratio as a function of the overall speed ratio for the fourth embodiment of the invention,

FIG. 6 shows a diagram of losses in the power split continuously variable transmission shown in FIG. 3 without lock up, and

FIG. 7 shows a diagram of losses in the power split continuously variable transmission shown in FIG. 3 using lock up and a reduction of the displacements of the first and second hydrostatic machines according to the invention.

### DETAILED DESCRIPTION

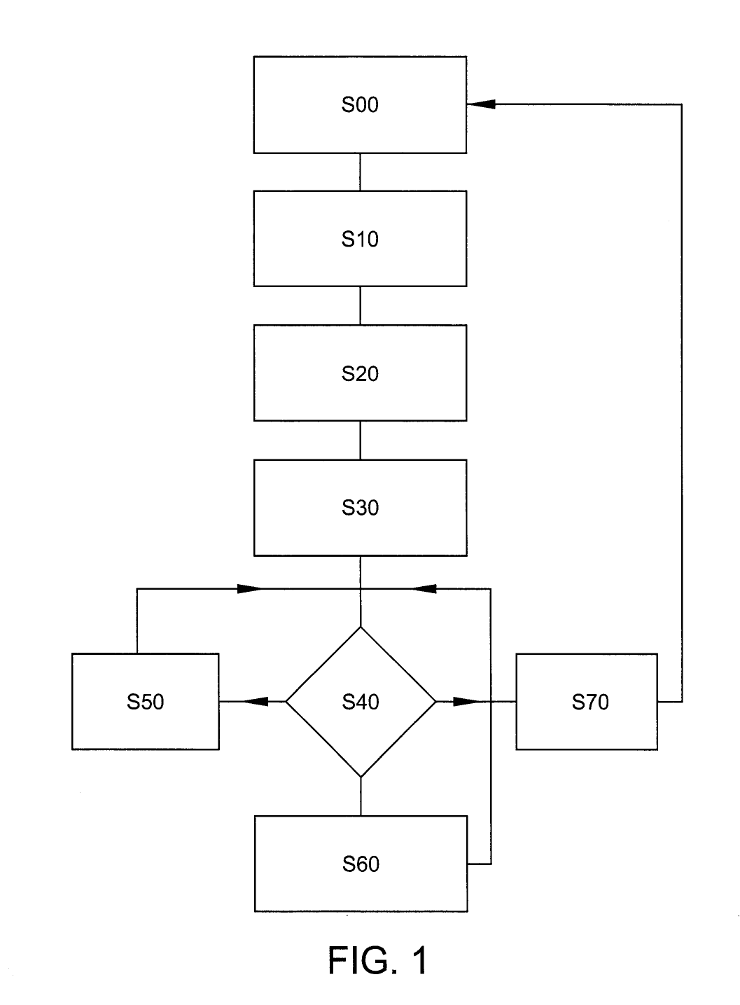

FIG. 1 shows a schematic flow chart of a method according to an aspect of the invention.

The method according to an aspect of the invention is used to control a power split continuously variable transmission which includes a variator unit having a first and a second variable displacement hydrostatic machine and a planetary gear unit. The power split continuously variable transmission is operable in at least two different modes. The modes are selected by engaging respective disengaging clutches included in the power split continuously variable transmission. Each mode is associated with a speed ratio range over the power split continuously variable transmission. The speed ratio ranges for pairs of the at least two modes may intersect at operating points where a mode change may take place. At these operating points the power split continuously variable transmission may be engaged in a lock up state. The power split continuously variable transmission has a fixed overall speed ratio at the lock up state.

In a first method step S00, it is verified that the power split continuously variable transmission is run at or near an operating point at which lock up is possible. The invention is particularly suitable for such power split continuously variable transmissions where changing between the first and second operating modes takes place at or nearby a maxima for a flow between the first and second hydrostatic machines in the variator unit.

It is further verified in a second method step S10 whether the dynamics of the operation of the gear box is such that it is suitable to operate the power split continuously variable transmission in lock up state. This will be the case if it is likely that the power split continuously variable transmission may be operated with a fixed gear ratio for a time period. The time period may extend for at least a few seconds. The decision may be based on data relating to the rotational velocity of the input shaft of the power split continuously variable transmission. Such data may be constituted by accelerator pedal position and accelerator pedal position derivative, engine speed, engine speed derivative. In cases with low degree of dynamics, that is, small changes in accelerator pedal position and/or engine speed, the power split continuously variable transmission may be allowed to assume a lock up state.

In a third method step S20 a lock up state of the power split continuously variable transmission is assumed by simultaneous engagement of clutches for two separate modes thereby providing a fixed gear ratio over the power split continuously variable transmission.

In a fourth method step S30, a simultaneous reduction of displacements of the first and second variable displacement hydrostatic machines takes place during at least a part of a lock up state of the power split continuously variable transmission. The reduction of displacement may be started as soon as the lock up state is initiated at synchronism over a clutch to be engaged to provide a fixed gear ratio over the continuously variable transmission. The lock up state is normally initiated by engagement of the clutch. The displacements of the first and second variable displacement hydrostatic machines have a value V1 and V2 before lock up takes place. These values are set to provide a desired speed ratio over the variator unit and to provide a desired torque transmitted over the variator unit. Once the lock up state is present, the displacements of the first and second variable displacement hydrostatic machines are reduced to finally assume reduced values v1 and v2 of the displacements. The displacements of the first and second variable displacement hydrostatic machines are set by separate actuators requiring a finite time for setting of the displacement. The quantity of reduction of the displacement may be adapted such that the displacements of the first and second variable displacement hydrostatic machines can reassume their initial values prior to termination of the lock up state. For this reason, the reduction of the displacements can be limited. A minimum value of the reduced values v1 and v2 may be decided based on accelerator pedal position, accelerator pedal position derivative, velocity data and acceleration data relating to the input shaft of the continuously variable transmission. In the event the degree of dynamics over the continuously variable transmission is low, that is, it is assumed that the rotational speed at the input shaft of the continuously variable transmission will be kept relatively constant for an extended period of time, the reduced values v1 and v2 may approach zero displacement.

The simultaneous reduction of the displacements is preferably performed such that the ratio of the displacement of the first hydrostatic machine to the displacement of the second hydrostatic machine is kept essentially constant during the simultaneous reduction.

In a fifth method step S40, it is decided whether a further reduction of the displacements is allowed, whether the reduced displacements should be maintained or whether the power split continuously variable transmission should be prepared for disengagement of the lock up state and enter into one of the modes with continuously variable speed ratio that may be selected from the lock up state.

A further reduction of the displacements is allowed in a sixth method step S50, the reduced displacement is maintained in a seventh method step S60 and the power split continuously variable transmission is prepared for disengagement of the lock up state by increasing the displacements to an initial value at an eighth step S70.

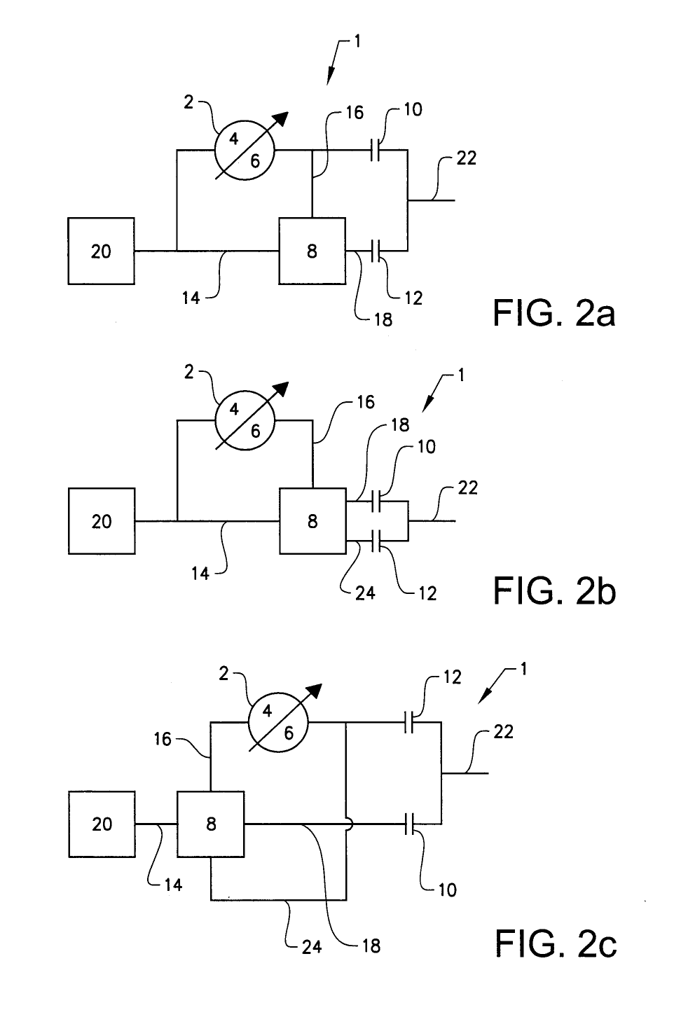

FIGS. 2a 2c show a power split continuously variable transmission 1 including a variator unit 2 having a first and a second variable displacement hydrostatic machine 4, 6 and a planetary gear unit 8. The power split continuously variable transmission 1 is operable in a first operating mode with a first speed ratio range by a selectively engagable first clutch 10, and in a second operating mode with a second speed ratio range by a selectively engagable second clutch 12. At a specific operating point of the variator unit 2 both the first and second clutches 10, 12 may be engaged to provide a lock up state with a fixed gear ratio over the power split continuously variable transmission 1.

The power split continuously variable transmission is arranged to be controlled to perform a simultaneous reduction of displacements of the first and second variable displacement hydrostatic machines 4, 6 during at least a part of the lock up state of the power split continuously variable transmission.

In FIG. 2a the planetary gear unit 8 includes a first, second and third shaft 14, 16, 18. The first shaft 14 is connected to the first hydrostatic machine 4 and being connectable to a prime mover 20. The second shaft 16 being connected to the second hydrostatic machine 6 and being selectively connectable to an output shaft 22 by the first clutch 10. The third shaft 18 being selectively connectable to the output shaft 22 via the second clutch 12. The power split continuously variable transmission 1 is operable in a hydrostatic mode by engagement of the first clutch 10 and disengagement of the second clutch 12. The power split continuously variable transmission 1 is further operable in an input coupled shunt mode by engagement of the second clutch 12 and disengagement of the first clutch 10. The power split continuously variable transmission 1 is also operable in a lock up state by engagement of both the first and second clutches 10, 12.

In FIG. 2b the planetary gear unit 8 includes a first, second, third and fourth shaft 14, 16, 18, 24. The first shaft 14 is connected to the first hydrostatic machine 4 and being connectable to a prime mover 20. The second shaft 16 is connected to the second hydrostatic machine 6. The third shaft 18 is selectively connectable to an output shaft 22 by the first clutch 10. The fourth shaft 24 is selectively connectable to the output shaft 22 via the second clutch 12. The power split continuously variable transmission 1 is operable in a first input coupled shunt mode by engagement of the first clutch 10 and disengagement of the second clutch 12. The power split continuously variable transmission 1 is further operable in a second input coupled shunt mode by engagement of the second clutch 12 and disengagement of the first clutch 10. The power split continuously variable transmission 1 is also operable in a lock up state by engagement of both the first and second clutches 10, 12.

In FIG. 2c the planetary gear unit 8 includes a first, second, third and fourth shaft 14, 16, 18, 24. The first shaft 14 is connectable to a prime mover 20. The second shaft 16 is connected to the first hydrostatic machine 4. The third shaft 18 is selectively connectable to an output shaft 22 by a first clutch 10. The fourth shaft 24 is connected to the second hydrostatic machine 6 and being selectively connectable to the output shaft 22 via a second clutch 12. The power split continuously variable transmission 1 is operable in a bridge mode by engagement of the first clutch 10 and disengagement of the second clutch 12. The power split continuously variable transmission 1 is furthermore operable in an output coupled shunt mode by engagement of the second clutch 12 and disengagement of the first clinch 10. The power split continuously variable transmission 1 is also operable in a lock up state by engagement of both the first and second clutches 10, 12.

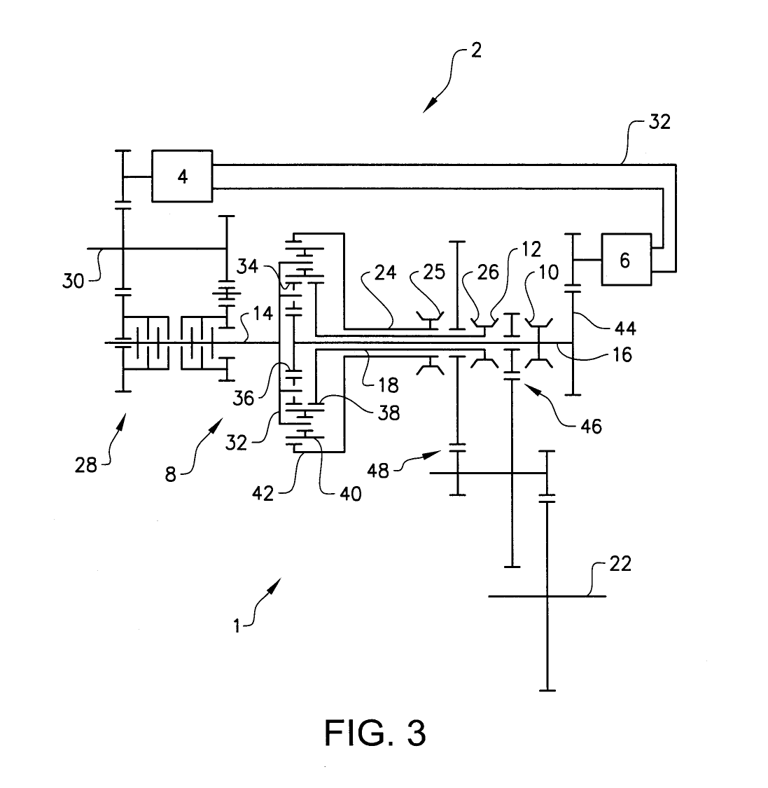

In FIG. 3 a fourth embodiment of an aspect of the invention is described in closer detail. The figure shows a power split continuously variable transmission 1 including a variator unit 2 having a first and a second variable displacement hydrostatic machine 4, 6 and a planetary gear unit 8. The power split continuously variable transmission 1 is operable in a first operating mode with a first speed ratio range by a selectively engagable first clutch 10, in a second operating mode with a second speed ratio range by a selectively engagable second clutch 12, a third speed ratio range by a selectively engagable third clutch 25, and a fourth speed ratio range by a selectively engagable fourth clutch 26. At a specific operating point of the variator unit 2 both the first and second clutches 10, 12 may be engaged to provide a lock up state with a fixed gear ratio over the power split continuously variable transmission 1, at another specific operating point of the variator unit 2 both the second and third clutches 12, 25 may be engaged to provide a lock up state with a fixed gear ratio over the power split continuously variable transmission 1, and at still another a specific operating point of the variator unit 2 both the third and fourth clutches 25, 26 may be engaged to provide a lock up state with a fixed gear ratio over the power split continuously variable transmission 1.

The planetary gear unit 8 is of a Ravigneaux type having a first shaft 14 connectable to a prime mover via a forward/reverse gear unit 28. The first shaft 4 is connected to an input shaft 30 via the forward/reverse gear unit 28. The input shaft 30 is connected to the first variable displacement hydrostatic machine 4 in the variator unit. The first variable displacement hydrostatic machine 4 is connected to a second variable displacement hydrostatic machine 6 via a hydraulic circuit 32 in a known manner. The first shaft 14 is connected to a planet carrier 32 carrying a first set of planet gears 34 being in meshing engagement with a first small sun gear 36 arranged on a second shaft 16 of the planetary gear unit. The second shaft 16 carries a gear wheel 44 being connected to the second hydrostatic machine 6. A second set of planet gears 40 is being in meshing engagement with the first set of planet gears 34 and a second larger sun gear 38 arranged on a third shaft 18. The third shaft 18 is arranged concentrically outside of the second shaft 16. The second set of planet gears 40 is being in meshing engagement with a ring gear 42 connected to a fourth shaft 24 of the planetary gear unit. The fourth shaft 24 is positioned concentrically outside of the third shaft 18.

The first clutch 10 is arranged for selectively connecting the second shaft 16 to an output shaft 22 via a first gear step 46. The second clutch 12 is arranged for selectively connecting the third shaft 18 to the output shaft 22 via the first gear step 46. The third clutch 25 is arranged for selectively connecting the fourth shaft 24 to the output shaft 22 via a second gear step 48. The fourth clutch 26 is arranged for selectively connecting the third shaft 18 to the output shaft 22 via the second gear step 48.

The planetary gear unit 8 provides four different modes in forward and reverse. A first hydrostatic mode when the first clutch 10 is engaged and three input-coupled shunt modes when the second, third and fourth clutches are engaged respectively.

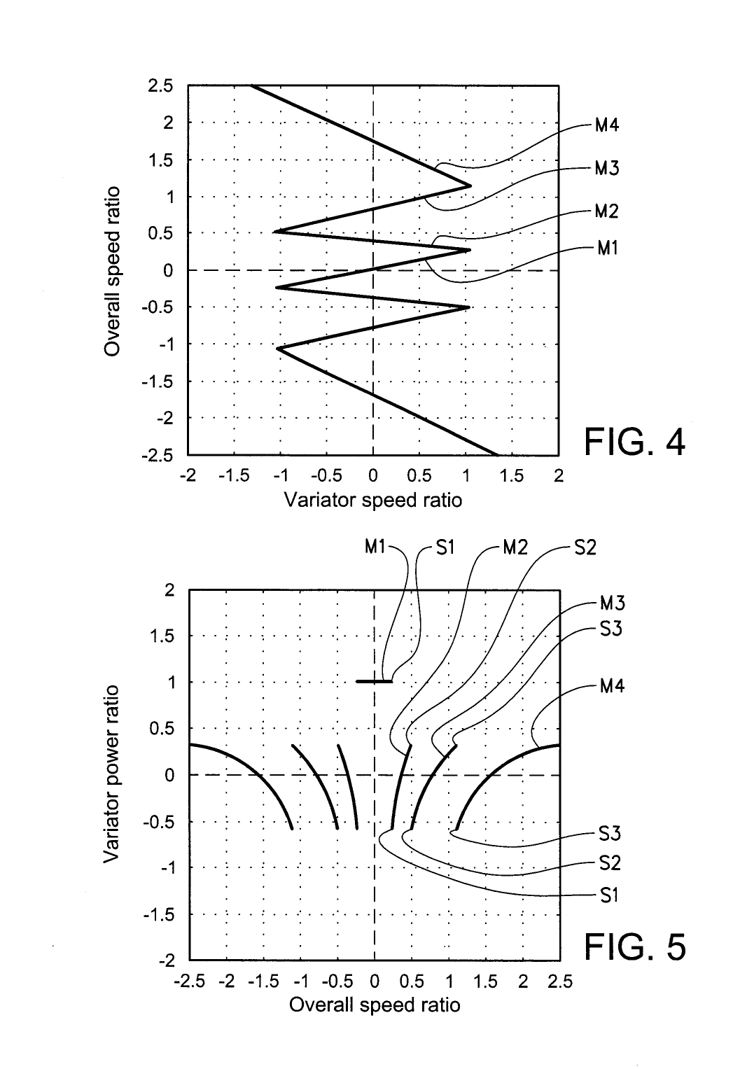

In FIG. 4 is shown a diagram with the overall speed ratio as a function of the variator speed ratio for the power split continuously variable transmission in FIG. 3. The speed ratios for the four different modes M1, M2, M3 and M4 are shown.

In FIG. 5 the variator power ratio as a function of the overall speed ratio is shown for the four different modes M1, M2, M3 and M4. The variator power ratio is defined as the ratio between the power transmitted through the variator and the total input power to the transmission. It can here be noted that the variator power ratio is high at mode shifts. Mode shifts take place at the locations S1, S2 and S3.

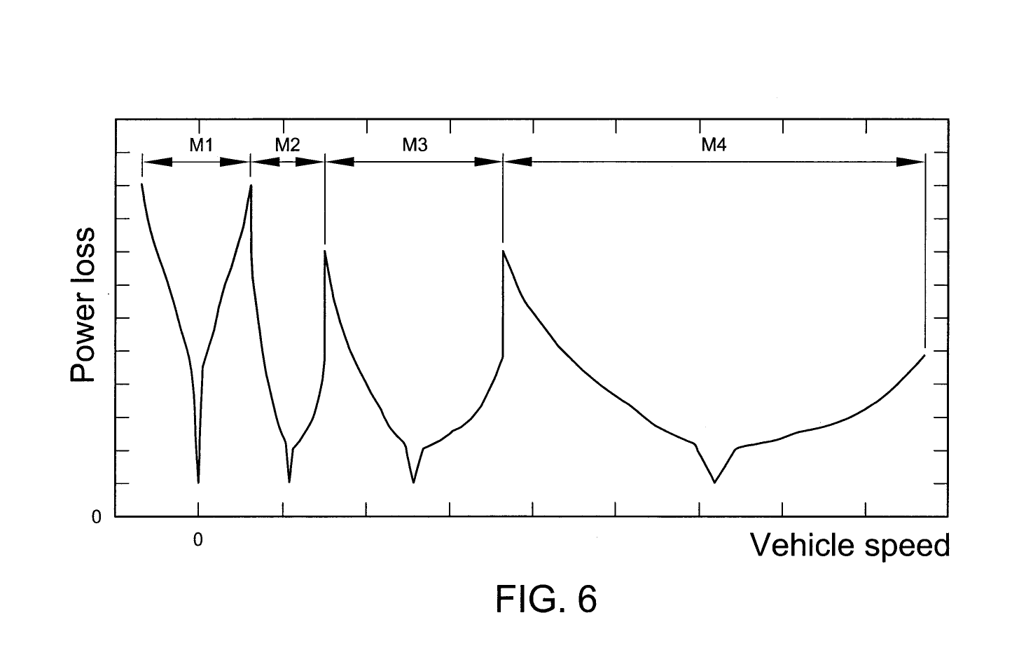

In FIG. 6 is shown a diagram of losses in the power split continuously variable transmission in FIG. 3 without lock up. The different modes M1, M2, M3, M4 are shown.

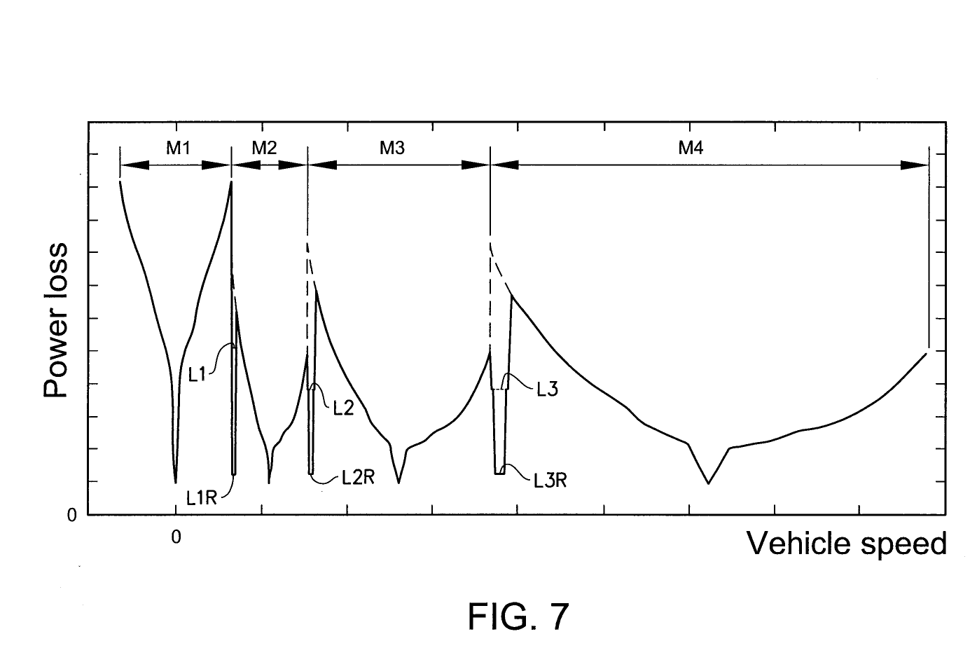

In FIG. 7 is shown a diagram of losses in the power split continuously variable transmission in FIG. 3 using lock up and reduction of the displacements. A first step in reducing losses as a result of the lock up state is indicated at locations L1, L2 and L3. A second step in reducing losses by reduction of displacements is indicated at locations L1R, L2R and L3R. It can here be seen that the losses are substantially reduced when the power split continuously variable transmission is in a lock up state combined with reduced displacements of the first and second variable displacement hydrostatic machines.

1. Method for controlling a power split continuously variable transmission, the transmission including a variator unit having a first and a second variable displacement hydrostatic machine and a planetary gear unit, comprising simultaneously reducing the displacements of the first and second variable displacement hydrostatic machines for reducing the flow between the first and second variable displacement hydrostatic machine during at least a part of a lock up state of the power split continuously variable transmission.

2. Method according to claim 1, comprising performing the simultaneous reduction of the displacements such that the ratio of the displacement of the first hydrostatic machine to the displacement of the second hydrostatic machine is kept constant during the simultaneous reduction.

3. Method according to claim 1, wherein the transmission is operable in a first operating mode with a first speed ratio range by a selectively engagable first clutch, and in a second operating mode with a second speed ratio range by a selectively engagable second clutch, comprising providing the lock up state by engagement of both the first and second clutches to provide a fixed gear ratio over the power split continuously variable transmission.

4. Method according to claim 3, comprising changing between the first and second operating modes takes place at or nearby a maxima for a flow between the first and second hydrostatic machines in the variator unit.

5. Method according to claim 3, comprising providing one of the first and second operating modes with an increasing overall speed ratio over the power split continuously variable transmission at increasing variator speed ratio, and the other of the first and second operating modes with a decreasing overall speed ratio over the power split continuously variable transmission at increasing variator speed ratio.

6. Method according to claim 5, wherein the speed ratio ranges intersect at a point with a common overall speed ratio over the power split continuously variable transmission, comprising controlling the both first and second clutches by engagement thereof at or nearby the point with a common overall speed ratio to provide the lock up state.

7. A power split continuously variable transmission including a variator unit having a first and a second variable displacement hydrostatic machine and a planetary gear unit, wherein the power split continuously variable transmission is arranged to be controlled to perform a simultaneous reduction of displacements of the first and second variable displacement hydrostatic machines for reducing the flow between the first and second variable displacement hydrostatic machine during at least a pan of a lock up state of the power split continuously variable transmission.

8. A power split continuously variable transmission according to claim 7, which transmission is operable in a first operating mode with a first speed ratio range by a selectively engagable first clutch, and in a second operating mode with a second speed ratio range by a selectively engagable second clutch, and the lock up state is provided by engagement of both the first and second clutches to provide a fixed gear ratio over the power split continuously variable transmission.

9. A power split continuously variable transmission according to claim 7, wherein the planetary gear unit includes a first, second and third shaft, the first shaft being connected to the first hydrostatic machine and being connectable to a prime mover, the second shaft being connected to the second hydrostatic machine and being selectively connectable to an output shaft by a first clutch, and the third shaft being selectively connectable to the output shaft via, a second clutch.

10. A power split continuously variable transmission according to claim 9, wherein the power split continuously variable transmission is operable in a hydrostatic mode by engagement of the first clutch and disengagement of the second clutch, the power split continuously variable transmission is operable in an input coupled shunt mode by engagement of the second clutch and disengagement of the first clutch, and the power split continuously variable transmission is operable in a lock up state by engagement of both the first and second clutches.

11. A power split continuously variable transmission according to claim 7, wherein the planetary gear unit includes a first, second, third and fourth shaft, the first shaft being connected to the first hydrostatic machine and being connectable to a prime mover, the second shaft being connected to the second hydrostatic machine, the third shaft being selectively connectable to an output shaft by a first clutch, and the fourth shaft being selectively connectable to the output shaft via a second clutch.

12. A power split continuously variable transmission according to claim 11, wherein the power split continuously variable, transmission is operable in a first input coupled shunt mode by engagement of the first clutch and disengagement of the second clutch, the power split continuously variable transmission is operable in a second input coupled shunt mode by engagement of the second clutch and disengagement of the first clutch, and the power split continuously variable transmission is operable in a lock up state by engagement of both the first and second clutches.

13. A power split continuously variable transmission, according to claim 7, wherein the planetary gear unit includes a first, second, third and fourth shaft, the first shaft being connectable to a prime mover, the second shaft being connected to the first hydrostatic machine, the third shaft being selectively connectable to an output shaft by a first clutch, and the fourth shaft being connected to the second hydrostatic machine and being selectively connectable to the output shaft via a second clutch.

14. A power split continuously variable transmission according to claim 13, wherein the power split continuously variable transmission is operable in a bridge mode by engagement of the first clutch and disengagement of the second clutch, the power split continuously variable transmission is operable in an output coupled shunt mode by engagement of the second clutch and disengagement of the first clutch, and the power split continuously variable transmission is operable in a lock up state by engagement of both the first and second clutches.

15. A power split continuously variable transmission according to claim 7, wherein the transmission is arranged to execute the method according to claim 1.
